(19) United States
(12) Patent Application Publication
(10) Pub. No.: US 2013/0323472 A1
(43) Pub. Date: Dec. 5, 2013

(54) METHOD FOR PRODUCING A PISTON RING HAVING EMBEDDED PARTICLES

(71) Applicant: Kristian Müller-Niehuus, Frankfurt a.M. (DE)

(72) Inventor: Kristian Müller-Niehuus, Frankfurt a.M. (DE)

(21) Appl. No.: 13/980,389

(22) PCT Filed: Nov. 7, 2011
(86) PCT No.: PCT/EP11/69535

§ 371 Date: Aug. 16, 2013

(30) Foreign Application Priority Data
Jan. 19, 2011 (DE) 10 2011 001 872.2

(51) Int. Cl. F16J 15/08

(52) U.S. Cl. CPC F16J 15/0806
USPC 428/172; 427/446; 216/94; 277/591; 428/411.1

(57) ABSTRACT

A method for producing a component with at least one functional element includes providing a substrate; enriching a plasma jet with material of the at least one functional element to be formed; and applying at least one functional element on the substrate, in that material in at least essentially liquid form is applied by means of the enriched plasma jet, connected to the substrate and consolidated.

The invention relates to a method for producing a component, in particular a flat component, with one or more functional elements, such as for example backland wave stoppers or combustion chamber stoppers. In particular, the invention relates to a method, wherein functional elements are applied by sintering by means of plasma jets.

Sintered stoppers, which are intended to serve as an example of such functional elements, are currently applied on a flat component by means of an expensive screen-printing process and are then burnt in and consolidated by means of a laborious and cost-intensive subsequent sintering process.

Proceeding from this, the problem of the invention consists in making available a simpler and more cost-effective method for applying functional elements.

According to a first aspect of the invention, a method is made available for producing a component with at least one functional element, comprising:
provision of a substrate;
enrichment of a plasma jet with material of the at least one functional element to be formed; and
application of at least one functional element on the substrate, in that material in at least essentially liquid form is applied by means of the enriched plasma jet, connected to the substrate and consolidated.

Functional elements can be applied on components in a very flexible way using the method according to the invention. Production can be carried out with minimum energy input and greatly reduced accumulation of waste material as a result of the targeted material application. A very high throughput per unit of time can be achieved by the application, which comprises simultaneous deposition, connection with the substrate and consolidation.

According to an embodiment, the point of impact of the plasma jet on the substrate is varied during the application.

The functional element can thus be formed gradually, in each case at the point of impact of the plasma jet. In order to form larger or longer functional elements related to the area of the point of impact, the point of impact can be varied during the application.

According to an embodiment, the variation of the point of impact of the plasma jet comprises moving the plasma jet in relation to the substrate and/or the substrate in relation to the plasma jet.

According to an embodiment, the variation of the point of impact of the plasma jet comprises varying the area of the point of impact in a time-dependent and/or location-dependent manner. This can be achieved for example by time- and/or location-dependent variable focusing and/or the distance to the point of impact.

This embodiment can for example produce a functional element with a location-dependent width.

According to an embodiment, the application takes place at a time-dependent and/or location-dependent deposition rate.

By means of a lower or higher deposition rate per unit of time, it is possible for example to generate a topography of the functional element running normal (z-direction) to the surface of the component.

Alternatively, by using a location-dependent dwell time of the plasma jet at each point of impact, a deposition quantity of the material of differing magnitude can be achieved in order to generate the z-topography.

According to an embodiment, the enrichment material is varied in a time-dependent and/or location-dependent manner. This involves the use of two or more different enrichment materials, which are used according to time and/or location. Multi-component materials can also be used, wherein the respective proportions of the plurality of components can be varied in a time-dependent and/or location-dependent manner.

With this embodiment, it is for example possible to use materials or material mixtures, e.g. comprising a deposition material A and a second material B, that differ depending on the location, in order to adjust properties of the functional element depending on the location.

According to an embodiment, the enrichment material comprises metal powder, sintering paste, soldering paste or combinations thereof.

The consolidation comprises sintering according to an embodiment.

According to an embodiment, the method further comprises a location-dependent adjustment of the contact angle between the substrate and the functional element. An improved distribution of stresses and an improved introduction of forces at the functional element into the component can be achieved by the variable adjustment of the contact angle. An increased introduction of stresses, for example at particularly stiff points of the component (for example in the installed state, depending on the situation with other components such as for example engines etc., to which the component according to the invention is fitted), can thus also be achieved in a targeted manner in order thereby to relieve the load on other less stiff points. Furthermore, it is thus possible to achieve, in a targeted manner, a stress distribution for example at particularly soft or less stiff points, in order thereby to relieve the load on these soft or less stiff points or to transfer forces in a targeted manner to stiff points.

The location-dependent adjustment of the contact angle between the substrate and the functional element can take place by means of a location-dependent variation of the enrichment material and/or a location-dependent surface treatment of the substrate. For example, the contact angle can be influenced as desired by targeted, location-dependent smoothing or roughening with a given material combination. Alternatively, this can be achieved by a location-dependent selection of the enrichment or coating material. A combination of surface treatment of the substrate and variation of the enrichment material is also possible.

According to an embodiment, the surface treatment can comprise one or more methods:
plasma activation;
etching;
cleaning;
grinding;
(preliminary) coating.

According to a further aspect of the invention, a component is made available, produced according to a method as described above.

According to an embodiment, the component is a flat component, for example a cylinder head gasket.

According to an embodiment, the at least one functional element is a backland wave stopper or a combustion chamber stopper.

According to an embodiment, the at least one functional element has a cross-section which comprises one or a combination of
arc of circle;
sector of circle;
circular layer
elliptical;
polygon;
spherical polygon;
half diamond;
kite; and
trapezium.

By a suitable choice of the cross-sectional shape, it is possible for example to control the diffusion of stresses when forces are introduced via the functional element into the component.

### BRIEF DESCRIPTION OF THE DRAWING

FIG. 1 shows a diagrammatic view of an embodiment of the invention;

FIG. 2 shows possible cross-sections of function elements according to the invention; and

FIG. 3 shows further possible cross-sections of functional elements according to the invention.

### DETAILED DESCRIPTION OF THE INVENTION

The following description relates, for the sake of simplicity, to flat components. The invention is however not limited to the latter, but can also be used for other components which are not necessarily flat.

The contact angle denotes the angle which a fluid on the surface of a solid makes with this surface. The contact angle is characteristic of various material combinations of the flat component and functional element.

The functional element can be surface-treated (cleaned, ground, plasma-activated, coated, etched). The nature of the surface treatment influences the contact angle with a given material combination and, according to the invention, can thus be used to achieve desired contact angles. A locally differing surface treatment makes it possible to form the contact angle in a location-dependent mariner, with an otherwise identical material selection of substrate/enrichment or coating material. In addition or as an alternative thereto, the selection of the materials, in particular of the coating or enrichment material, can be made accordingly in order to obtain the desired contact angle.

With regard to the use, within the meaning of the present invention, in connection with the functional elements on a substrate surface, this means: A contact angle is assumed at which the occurring stresses in the functional element are transmitted to the flat component in the optimum manner, i.e. for example without stress concentration and thus protecting the material. This optimum angle can be endowed subsequently on a functional element in the form of a solid in a time-consuming and labour-intensive manner by mechanical/chemical processing, with all the tolerances and other drawbacks that thereby arise.

However, the inventor has found that a liquid can instead be used according to the invention in order to apply the functional element. Since the liquid will by itself seek to form the optimum contact angle, it is possible in this case, according to the invention, to dispense with problematic post-processing to obtain the angle.

A further advantage consists in the fact that liquids wet, whereas solids usually only lie on a few contact points. Thus, by using a liquid for forming the functional element, an improved stress distribution in the component overall is also achieved, since the contact area between the functional element and the flat component is enlarged. The invention thus makes use of the wetting capabilities of a liquid.

On the one hand, the functional element is thus joined overall with the flat component, in contrast with spot welding or linear welding. On the other hand, it is possible with a suitable material choice of the functional element and the component to generate a wetting angle which achieves the desired property of force focusing, force distribution or force defocusing in the end product.

The invention thus also relates to the targeted selection and adjustment of a specific contact angle in order in this way to obtain a specific kind of stress distribution. A right angle between a solid functional element and a flat component, for example, produces stress peaks. In contrast, the stress can be better distributed by a contact angle less than 90°. A consciously employed stress concentration is also advisable, for example, when the structural stiffness of an engine varies greatly and forces are to be introduced only in structurally strong regions, or when high pressing values have to be achieved for the purpose of sealing. In this case, the stress can be better concentrated on the appropriate points by a contact angle greater than 90°.

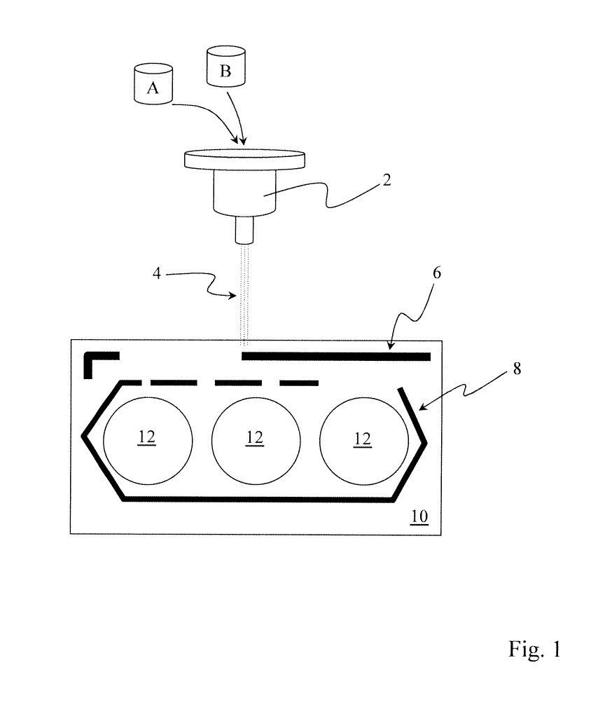

FIG. 1 shows, in a diagrammatic form, the mode of functioning of the method according to the invention. Materials A and B (here two different ones) can be fed to plasma jet apparatus 2. These materials can for example comprise metal powder, soldering pastes, sintering pastes etc. In an alternative embodiment not shown, another number of different materials can be used. The use of multi-component materials is also possible, wherein the proportions of the plurality of components can then optionally also be varied.

Plasma jet 4 enriched, for example, with sintering paste can then be orientated in a targeted and precise manner, e.g. by means of a robot or traversing table, onto an arbitrary position on flat component 10. At the position arrived at, a simultaneous application, connection and consolidation (sintering) of the sintering powder liquefied in the plasma jet then takes place on flat component 10 by means of plasma jet 4 in order to form a part of the functional element.

Interconnected functional elements of arbitrarily geometry (both in the X- and Y-direction as well as in the Z-direction=topography) can be produced by moving plasma jet 4 farther along prescribed paths and employing a continuous deposition. By repeatedly arriving at a specific point and/or by increasing the enrichment or deposition rate of plasma jet 4, the height of the functional element can be adjusted as desired. It is thus also possible to create the cross-section of the functional element as desired (i.e. a wide base and tapering tip of the functional element for example).

In advanced embodiments, the area and/or the shape of the point of impact of the jet is varied in a location-dependent and/or time-dependent manner (for example with repeated coating of the same point in order to generate a topography), in order to form functional elements with an adjustable cross-section and/or an adjustable course.

A combustion chamber stopper 8 for combustion chambers 12 and a backland wave stopper 6 are shown by way of example in FIG. 1 for possible functional elements.

As an alternative to moving plasma jet 4 in relation to the component, flat component 10 itself can be moved with respect to plasma jet 4.

As a rule, the cross-section of the functional element, of a sintered stopper for example, follows a curved contour. Typical contours are listed below. These can be constituted either asymmetrical, symmetrical or completely irregular.

1. arc of circle

2. sector of circle

3. circular layer

4. elliptical contour

5. polygon (1-n corners)

6. spherical polygon (1-n corners)

7. half diamond, kite, trapezium

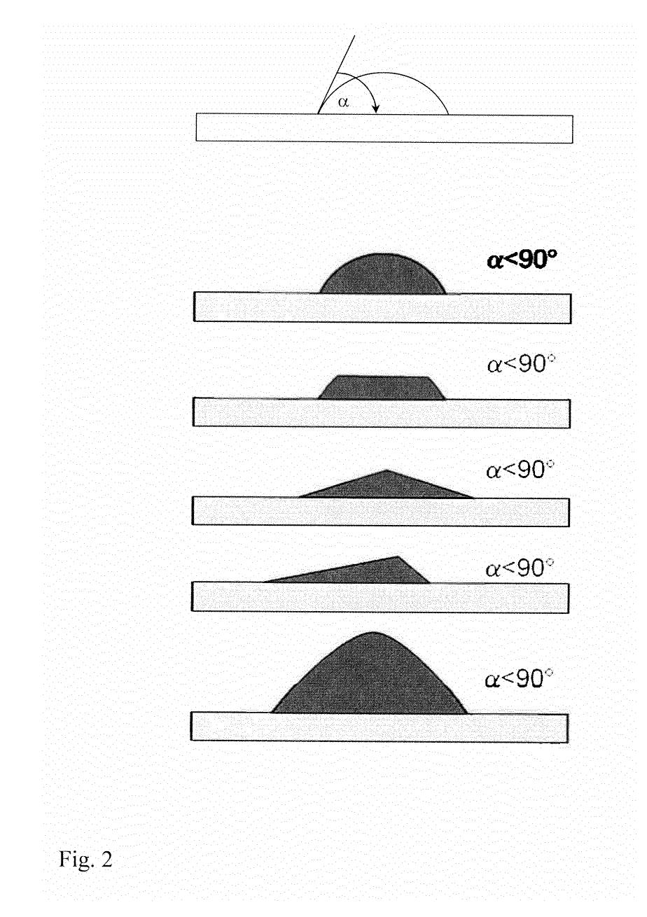

It is characteristic of these cross-sectional geometries that they form an angle between the flat component and the sintered functional element, as represented in FIG. 2. This contact angle (also referred to as wetting angle) can lie between 0° (zero) degrees and less than 180°. In the case of angles much smaller than 90°, one speaks of hydrophilic, in the case of an angle around 90° of hydrophobic and in the case of angles much greater than 90° of super-hydrophobic.

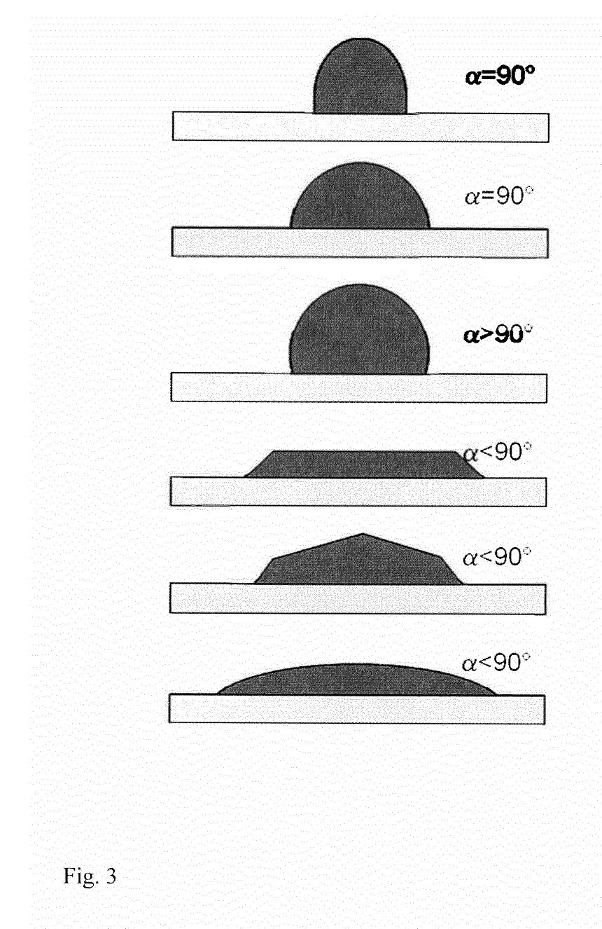

Further possible cross-sectional shapes are shown in FIG. 2, and further different ones in FIG. 3.

It is an advantage of the method proposed by the invention that materials can be selected which have optimum contact angles with regard to optimisation, for example, of the diffusion of stresses, of stress distributions in the functional element or the flat component. A further advantage consists in the fact that, by a suitable choice of or the influencing of the contact angle, an exact and space-saving build-up of material at right angles to the flat component can be achieved. By the targeted selection or influencing of the contact angle, either an improved stress distribution can be achieved, or a conscious concentration of the stresses can be provided in regions which are better able to accommodate these stresses than other regions, which are in turn relieved of load.

The invention offers the following advantages:
a) cost-saving: functional elements can be produced in a manner that avoids waste and saves energy.
b) increase in production throughput per time cycle on account of the absence of time-consuming sintering.
c) careful treatment of material: in contrast with embossed stoppers, no impairment of the component structure occurs due to embossing or drawing.
d) use of optimum materials: instead of the use of uniform or all-in-one solutions, which always involves compromises, functional elements tailored to the given application can be applied solely at targeted and required points by using the invention.
e) new design options: the generation of a topography is possible, a smaller type of construction is also possible, since functional elements can be applied at points of the component which were hitherto too thin.

1. A method for producing a component with at least one functional element, comprising
provision of a substrate;
enrichment of a plasma jet with material of the at least one functional element to be formed; and
application of at least one functional element on the substrate, in that material in at least essentially liquid form is applied by means of the enriched plasma jet, connected to the substrate and consolidated.

2. The method according to claim 1, wherein the point of impact of the plasma jet on the substrate is varied during the application.

3. The method according to claim 2, wherein the varying of the point of impact of the plasma jet comprises moving the plasma jet in relation to the substrate and/or the substrate in relation to the plasma jet.

4. The method according to claim 2 or 3, wherein the varying of the point of impact of the plasma jet comprises varying the area of the point of impact in a time-dependent and/or location-dependent manner.

5. The method according to any one of the preceding claims, wherein the application takes place at a time-dependent and/or location-dependent deposition rate.

6. The method according to any one of the preceding claims, wherein the enrichment material is varied in a time-dependent and/or location-dependent manner.

7. The method according to any one of the preceding claims, wherein the enrichment material comprises metal powder, sintering paste, soldering paste or combinations thereof.

8. The method according to any one of the preceding claims, wherein the consolidation comprises sintering.

9. The method according to any one of the preceding claims, further comprising location-dependent adjustment of the contact angle between the substrate and the functional element by:
location-dependent variation of the enrichment material; and/or
location-dependent surface treatment of the substrate.

10. The method according to claim 9, wherein the surface treatment comprises one or more of:
plasma activation;
etching;
cleaning;
grinding;
coating.

11. A component produced by a method according to any one of the preceding claims.

12. The component according to claim 11, wherein the component is a flat component.

13. The component according to claim 11 or 12, wherein the at least one functional element is a backland wave stopper or a combustion chamber stopper.

14. The component according to any one of claims 11 to 13, wherein the at least one functional element has a cross-section which comprises one or a combination of:
arc of circle;
sector of circle;
circular layer
elliptical;
polygon;
spherical polygon;
half diamond;
kite; and
trapezium.
